(19) United States
(12) Patent Application Publication
(10) Pub. No.: US 2025/0360938 A1
(43) Pub. Date: Nov. 27, 2025

(54) INFORMATION PROCESSING DEVICE, INFORMATION PROCESSING METHOD, AND PROGRAM

(71) Applicant: HONDA MOTOR CO., LTD., Minato-ku, Tokyo (JP)

(72) Inventor: Takamasa Koshizen, Wako-shi (JP)

(21) Appl. No.: 18/873,744

(22) PCT Filed: Jun. 13, 2023
(86) PCT No.: PCT/JP2023/021897

§ 371 Date: Dec. 11, 2024

(30) Foreign Application Priority Data
Jun. 13, 2022 (JP) 2022-094965

(51) Int. Cl. B60W 50/14; B60W 50/00; G06V 20/58

(52) U.S. Cl. CPC B60W 50/14; B60W 50/0097; G06V 20/58; B60W 2050/143; B60W 2050/146

(57) ABSTRACT

There is provided an information processing device including a recognition unit that recognizes an object included in image data obtained by capturing an image of a vicinity of a mobile body, a prediction unit that predicts a future trajectory of the object, and a notification control unit that causes a notification device to notify a vehicle occupant in the mobile body of the presence of the object based on the future trajectory of the object, in which the notification control unit changes a mode of notification by the notification device between a case where the object is predicted to approach the mobile body from behind the mobile body and a case where the object is predicted to pass by a side of the mobile body.

### TECHNICAL FIELD

The present invention relates to an information processing device, an information processing method, and a program.

### BACKGROUND ART

In the related art, a technique for notifying a vehicle occupant of the presence of another vehicle traveling in the vicinity of the vehicle is known. For example, Patent Document 1 discloses a technique that commands a warning device installed in the vehicle to issue a warning in a case where the relative traveling speed, which is the difference between a traveling speed of a rear vehicle and a traveling speed of the host vehicle itself, is equal to or larger than a first threshold value or in a case where a change in the relative traveling speed is equal to or larger than a second threshold value.

### CITATION LIST

### Patent Document

[Patent Document 1] Japanese Unexamined Patent Application, First Publication No. 2020-129178

### SUMMARY OF INVENTION

### Technical Problem

However, in the related art, there is a case where it is not possible to notify a vehicle occupant in a mobile body in an optimal manner according to the predicted future trajectory of a surrounding object.

The present invention has been made in consideration of the above circumstances, and an object of the present invention is to provide an information processing device, an information processing method, and a program, which make it possible to notify a vehicle occupant in a mobile body in an optimal manner according to the predicted future trajectory of a surrounding object.

### Solution to Problem

The information processing device, the information processing method, and the program according to the present invention employ the following configurations.
(1): An information processing device according to one aspect of the present invention includes a recognition unit that recognizes an object included in image data obtained by capturing an image of a vicinity of a mobile body;
a prediction unit that predicts a future trajectory of the object; and
a notification control unit that causes a notification device to notify a vehicle occupant in the mobile body of the presence of the object based on the future trajectory of the object,
wherein the notification control unit changes a mode of notification by the notification device between a case where the object is predicted to approach the mobile body from behind the mobile body and a case where the object is predicted to pass by a side of the mobile body.
(2): The information processing device according to the aspect (1),
wherein the notification device is a voice output device, and
the notification control unit causes the voice output device to output a warning sound in a case where the object is predicted to approach the mobile body from behind the mobile body and the mobile body has entered a first predetermined area.
(3): The information processing device according to the aspect (1),
wherein the notification control unit outputs a warning sound indicating whether the side is left or right in a case where the object is predicted to pass by the side of the mobile body and the mobile body has entered a second predetermined area.
(4): The information processing device according to the aspect (2),
wherein the notification control unit outputs a warning sound indicating whether the side is left or right in a case where the object is predicted to pass by the side of the mobile body and the mobile body has entered a second predetermined area,
the first predetermined area is an area that is present within a first distance from the mobile body, and
the second predetermined area is an area that is present away from the mobile body by the first distance or more and within a second distance that is larger than the first distance.
(5): The information processing device according to the aspect (1),
wherein the notification device is a display device,
the information processing device further includes a reception unit that receives instruction information indicating whether the mobile body is a four-wheel vehicle or a two-wheel vehicle, and
in a case where the reception unit receives instruction information indicating that the mobile body is a two-wheel vehicle, the notification control unit causes the display device to display a predetermined figure in a central part of the display device in a case where the object is predicted to approach the mobile body from behind the mobile body and the mobile body has entered a first predetermined area.
(6): The information processing device according to the aspect (1), wherein the notification device is a display device,
the information processing device further includes a reception unit that receives instruction information indicating whether the mobile body is a four-wheel vehicle or a two-wheel vehicle, and
in a case where the reception unit receives instruction information indicating that the mobile body is a four-wheel vehicle, the notification control unit causes the display device to dynamically display a predetermined figure diagonally upward from a lower left corner portion or a lower right corner portion of the display device, which corresponds to a direction in which the object has entered, in a case where the object is predicted to pass by the side of the mobile body and the mobile body has entered a second predetermined area.
(7): The information processing device according to the aspect (6), wherein the notification control unit increases a speed at which the predetermined figure is dynamically displayed as a relative speed of the object with respect to a speed of the mobile body increases.
(8): The information processing device according to the aspect (6), wherein the notification control unit increases a size of the predetermined figure as the object approaches the mobile body.
(9): An information processing method according to another aspect of the present invention is such that a computer recognizes an object included in image data obtained by capturing an image of a vicinity of a mobile body;
predicts a future trajectory of the object;
causes a notification device to notify a vehicle occupant in the mobile body of the presence of the object based on the future trajectory of the object; and
changes a mode of notification by the notification device between a case where the object is predicted to approach the mobile body from behind the mobile body and a case where the object is predicted to pass by a side of the mobile body.
(10): A program according to another aspect of the present invention causes a computer to recognize an object included in image data obtained by capturing an image of a vicinity of a mobile body such that a future trajectory of the object is predicted, and causes a notification device to notify a vehicle occupant in the mobile body of the presence of the object based on the future trajectory of the object such that a mode of notification by the notification device is changed between a case where the object is predicted to approach the mobile body from behind the mobile body and a case where the object is predicted to pass by a side of the mobile body.
(11): A program according to another aspect of the present invention causes a computer to recognize an object included in image data obtained by capturing an image of a vicinity of a two-wheel vehicle such that a future trajectory of the object is predicted, causes a notification device to notify a vehicle occupant in the two-wheel vehicle of the presence of the object based on the future trajectory of the object, causes the computer to change a mode of notification by the notification device between a case where the object is predicted to approach the two-wheel vehicle from behind the two-wheel vehicle and a case where the object is predicted to pass by a side of the two-wheel vehicle, and causes the notification device to display a predetermined figure in a central part of the notification device in a case where the object is predicted to approach the two-wheel vehicle from behind the two-wheel vehicle and the mobile body has entered a first predetermined area.
(12): A program according to still another aspect of the present invention causes a computer to recognize an object included in image data obtained by capturing an image of a vicinity of a four-wheel vehicle such that a future trajectory of the object is predicted,
causes a notification device to notify a vehicle occupant in the four-wheel vehicle of the presence of the object based on the future trajectory of the object,
causes the computer to change a mode of notification by the notification device between a case where the object is predicted to approach the four-wheel vehicle from behind the four-wheel vehicle and a case where the object is predicted to pass by a side of the four-wheel vehicle, and
causes the notification device to dynamically display a predetermined figure diagonally upward from a lower left corner portion or a lower right corner portion of the notification device, which corresponds to a direction in which the object has entered, in a case where the object is predicted to pass by the side of the four-wheel vehicle and the mobile body has entered a second predetermined area.

### Advantageous Effects of Invention

According to the aspects (1) to (12), it is possible to notify a vehicle occupant in a mobile body in an optimal manner according to the predicted future trajectory of a surrounding vehicle.

### BRIEF DESCRIPTION OF DRAWINGS

FIG. 1 is a view showing an example of a configuration of an on-vehicle camera 10 and a terminal device 100, which are mounted in a host vehicle M.

FIG. 2 A view for an explanatory description of a method in which a prediction unit 150 predicts a future trajectory of an object.

FIG. 3 A view showing a schematic view of a density distribution.

FIG. 4 A view showing the height of a density value D along a line 4-4 in FIG. 3.

FIG. 5 is another view for the explanatory description of the method in which the prediction unit 150 predicts a future trajectory of an object.

FIG. 6 A view showing an example of a case where an object is predicted to approach the host vehicle M from behind the host vehicle M and a case where an object is predicted to pass by a side of the host vehicle M.

FIG. 7 A view showing an example of a predetermined area behind the host vehicle M and a predetermined area on the side of the host vehicle M, which are used in order for a control unit 160 to determine whether or not notification is necessary.

FIG. 8 A view showing another example of a predetermined area behind the host vehicle M and a predetermined area on the side of the host vehicle M, which are used in order for a control unit 160 to determine whether or not notification is necessary.

FIG. 9 A view for an explanatory description of an operation of a notification device in a case where an object has entered a central area CA.

FIG. 10 A view for an explanatory description of an operation of the notification device in a case where an object has entered a left area LA.

FIG. 11 A view for an explanatory description of an operation of the notification device in a case where an object has entered a right area RA.

FIG. 12 A view showing an example of a reception screen IM1 for instruction information that is received by a reception unit 170.

FIG. 13 A view showing an example of a screen that is displayed by a display unit 120 in a case where the host vehicle M] A two-wheel vehicle.

FIG. 14 A view showing an example of a screen that is displayed by the display unit 120 in a case where the host vehicle M] A four-wheel vehicle.

FIG. 15 A flowchart showing an example of a flow of processing that is executed by a terminal device 100.

FIG. 16 A flowchart showing another example of the flow of processing that is executed by the terminal device 100.

### DESCRIPTION OF EMBODIMENTS

Hereinafter, embodiments of an information processing device, an information processing method, and a program according to the present invention will be described with reference to the drawings.

### Configuration

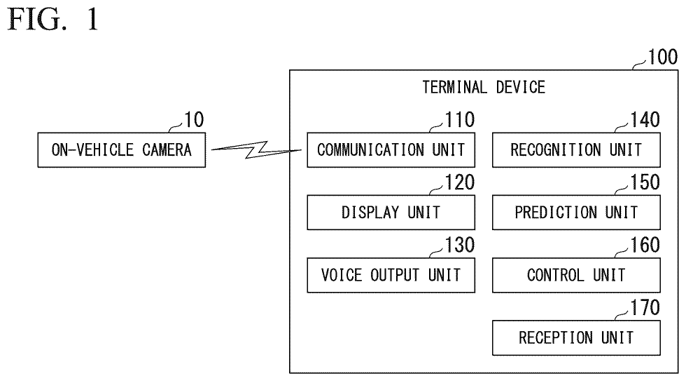

FIG. 1 is a view showing an example of a configuration of an on-vehicle camera 10 and a terminal device 100, which are mounted in a host vehicle M. The host vehicle M is, for example, a two-wheel vehicle or a four-wheel vehicle, and the drive source thereof is an internal combustion engine such as a diesel engine or a gasoline engine, an electric motor, or a combination of these. The electric motor is operated using electric power generated by a generator connected to an internal combustion engine, or discharged electric power from a secondary battery or a fuel cell.

An on-vehicle camera 10 is a camera attached to the host vehicle M. The on-vehicle camera 10 includes a camera that is mounted at a position where an image of at least the rear of the host vehicle M can be captured, and it is installed so that an image of the scenery outside the vehicle is captured through the rear windshield or the lens is exposed outside the vehicle, whereby an image of the vicinity outside the vehicle is directly captured. The on-vehicle camera 10 transmits a captured image IM obtained by capturing an image of the vicinity outside the vehicle to a terminal device 100 via wireless communication using a method such as Bluetooth (registered trademark) or Wi-Fi.

The terminal device 100 is, for example, a portable terminal device such as a smartphone. In a case where the host vehicle M is a four-wheel vehicle, the terminal device 100 is used by being set in a holder that is provided, for example, on a passenger compartment side of a front windshield of a vehicle. In a case where the host vehicle M is a two-wheel vehicle, the terminal device 100 is used by being set in a holder that is provided, for example, in a vicinity of a handle of a vehicle. That is, in any case, the terminal device 100 is set at a position where the vehicle occupant in the host vehicle M can view a display unit 120 of the terminal device 100.

The communication unit 110 is a wireless communication device that uses a system such as the above-described Bluetooth (registered trademark) or Wi-Fi. The communication unit 110 communicates with the on-vehicle camera 10 to receive the image IM that is obtained by capturing an image of the vicinity outside the vehicle.

The display unit 120 is, for example, a display device such as a touch panel or a liquid crystal display. The display unit 120 displays information on an object relating to the vicinity of the host vehicle M in accordance with the control by a control unit 160 described below.

The voice output unit 130 is, for example, a speaker device. The voice output unit 130 outputs information on an object relating to the vicinity of the host vehicle M by voice output in accordance with the control by the control unit 160. The display unit 120 and the voice output unit 130 are an example of a “notification device.”

The terminal device 100 further includes a recognition unit 140, a prediction unit 150, a control unit 160, and a reception unit 170. The recognition unit 140, the prediction unit 150, the control unit 160, and the reception unit 170 are realized by, for example, allowing a hardware processor such as a central processing unit (CPU) to execute a program (software). A part or all of these components may be realized by hardware (including circuitry) such as a large scale integration (LSI), an application specific integrated circuit (ASIC), a field-programmable gate array (FPGA), or a graphics processing unit (GPU) or may be realized by the cooperation of software and hardware. The program may be stored in advance in a storage device such as a hard disk drive (HDD) or a flash memory (a storage device having a non-transient storage medium) or may be stored in a removable storage medium (non-transient storage medium) such as a DVD or CD-ROM, thereby being installed by inserting the storage medium into a drive device. The recognition unit 140, the prediction unit 150, the control unit 160, and the reception unit 170 may hereinafter be referred to as a “driving assistance application”. In addition, the terminal device 100 equipped with a driving assistance application is an example of an “information processing device.”

The recognition unit 140 recognizes the object pictured in the image that has been captured by the on-vehicle camera 10. More specifically, for example, in a case where an image captured by the on-vehicle camera 10 is input, the recognition unit 140 recognizes an object using a trained model that has been trained to output information such as the presence, position, and type of the object. The recognition unit 140 uses this trained model to identify the area occupied by the vehicle in the captured image IM while distinguishing the types of the two-wheel vehicle, four-wheel vehicle, and the like.

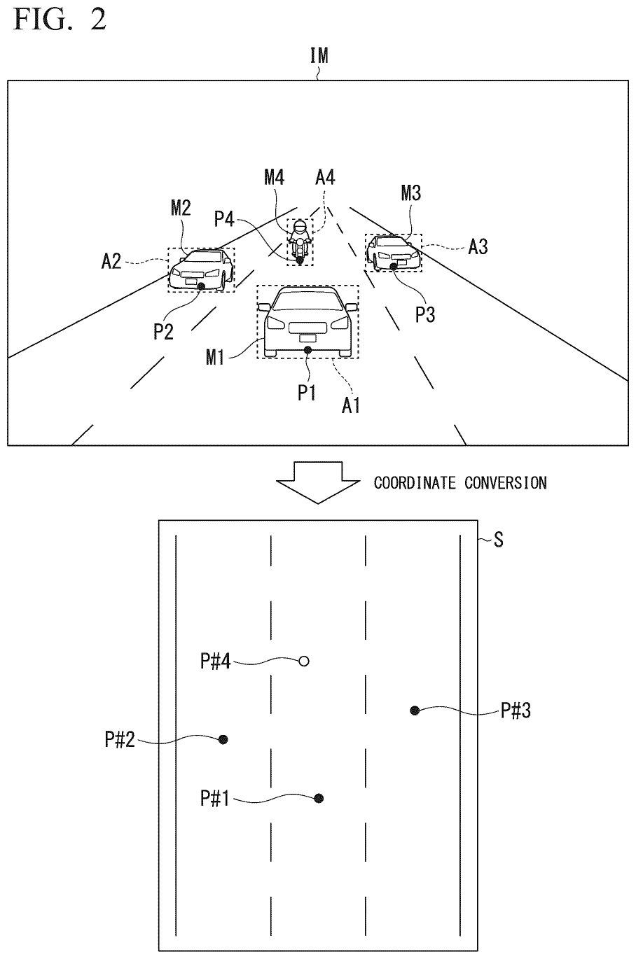

The prediction unit 150 predicts a future trajectory of the object recognized by the recognition unit 140. FIG. 2 is a view for an explanatory description of a method in which the prediction unit 150 predicts a future trajectory of the object. In a case where a plurality of vehicles are captured in the captured image IM, the prediction unit 150 carries out the processing described below for each of the plurality of vehicles. FIG. 2 shows a case where the on-vehicle camera 10 captures an image of the rear of the host vehicle M.

The prediction unit 150 first identifies a position, for example, in the vicinity of the center of the lower end part of the region identified by the recognition unit 140, as the position of the vehicle on the image plane of the captured image. In FIG. 2, A1 to A4 indicate the areas occupied by the identified vehicles M1 to M4, respectively, and P1 to P4 indicate the positions of the identified vehicles M1 to M4, respectively. In the figure, M1 to M3 are four-wheel vehicles, and M4 is a two-wheel vehicle.

Further, the prediction unit 150 converts the position of the vehicle on the image plane into the position of the vehicle on the virtual plane S. The virtual plane S is a virtual plane obtained in a case of being seen from above, and it approximately coincides with the road plane. The prediction unit 150 identifies the position of the representative point of the vehicle on the virtual plane S based on, for example, a conversion rule for converting coordinates on the image plane into coordinates on the virtual plane. P #1 to P #4 in FIG. 2 indicate positions on the virtual plane S of the vehicles M1 to M4, respectively.

The prediction unit 150 sets, on the virtual plane S, an index value I having a distribution according to a position of a vehicle, based on each of the acquired positions of the plurality of vehicles. The index value I is set, for example, so that the contour lines form a shape of circles with the position of the vehicle being the center of the circles. In a case where the height is used for the index value I, the distribution of the indices on the virtual plane S has a dome-like shape in which the position of the vehicle is at the ceiling. The prediction unit 150 may or may not change the degree of density spread depending on the vehicle model.

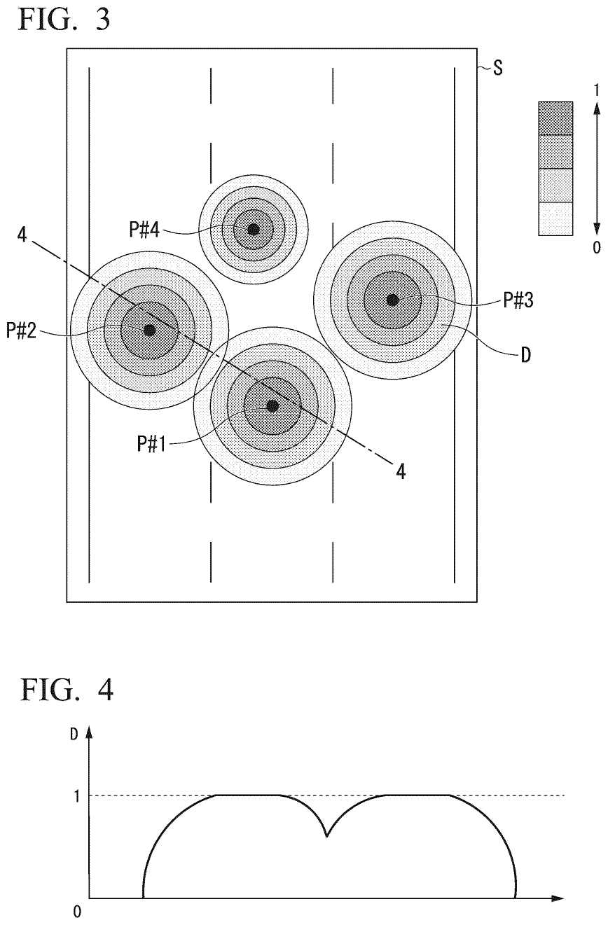

Then, the prediction unit 150 generates the density distribution information by superimposing the index values I calculated for a plurality of vehicles (by adding them up for each coordinate on the virtual plane S). Hereinafter, the value obtained by adding up the index values for a plurality of vehicles will be referred to as a density value D. The index value I and the density value D may be set to have a specified value (for example, 1) as the upper limit thereof. In this case, in a case where the result obtained by adding up the index values I, which is determined for a plurality of vehicles, exceeds a specified value, the prediction unit 150 sets the specified value at that point as the density value D. FIG. 3 is a view showing a schematic view of a density distribution. FIG. 4 is a view showing the height of a density value D along a line 4-4 in FIG. 3.

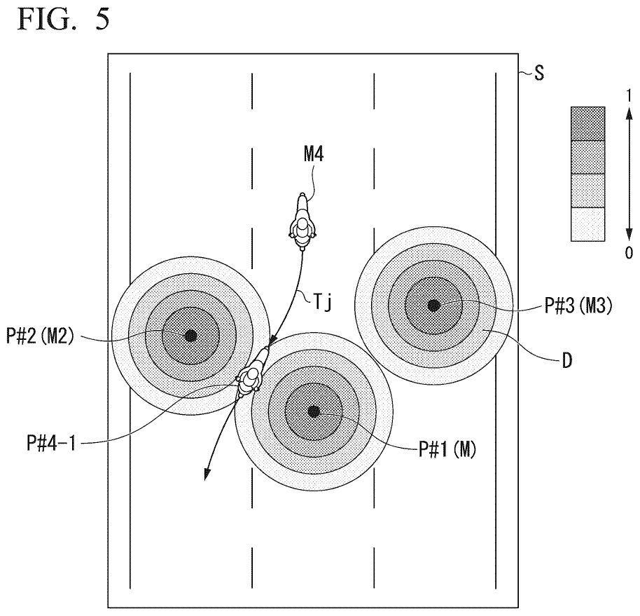

FIG. 5 is another view for the explanatory description of the method in which the prediction unit 150 predicts a future trajectory of an object. As illustratively shown in the figure, the prediction unit 150 estimates that a target vehicle M4 will travel along a trajectory Tj that is obtained by lining points having a small density value D (a valley in the density distribution). In addition, the prediction unit 150 predicts that the acceleration of the target vehicle M4 will be small (including negative acceleration, that is, deceleration) in a section where the density value D increases between points along the trajectory Tj (a section up to a point P #4-1 in the figure) and that the acceleration of the target vehicle M4 will be large in a section where the density value D decreases between the points (a section after the point P #4-1 in the figure). Based on these predictions, the prediction unit 150 generates a future speed profile of the target vehicle M4. In this case, the prediction unit 150 may predict the acceleration will be small as compared with a case where the rate of rise is small, in a case where the rate of rise is large between points of the density values D (the gradient in the positive direction is large), and the prediction unit 150 may predict that the acceleration will be large as compared with a case where the rate of decline is small, in a case where the rate of decline is large between points of the density values D (the gradient in the negative direction is large). Since it is assumed that the target vehicle will accelerate significantly in a scene in which the field of view of the target vehicle suddenly opens up, the prediction unit 150 can more accurately predict the behavior of the target vehicle in such a scene.

The control unit 160 causes the display unit 120 or the voice output unit 130 to notify a vehicle occupant of the presence of the object based on the future trajectory of the object which has been predicted by the prediction unit 150 (hereinafter, the display unit 120 and the voice output unit 130 may be collectively referred to as a “notification device”). More specifically, the control unit 160 changes the mode of notification by the notification device between a case where an object is predicted to approach the host vehicle M from behind the host vehicle M and a case where the object is predicted to pass by the side of the host vehicle M.

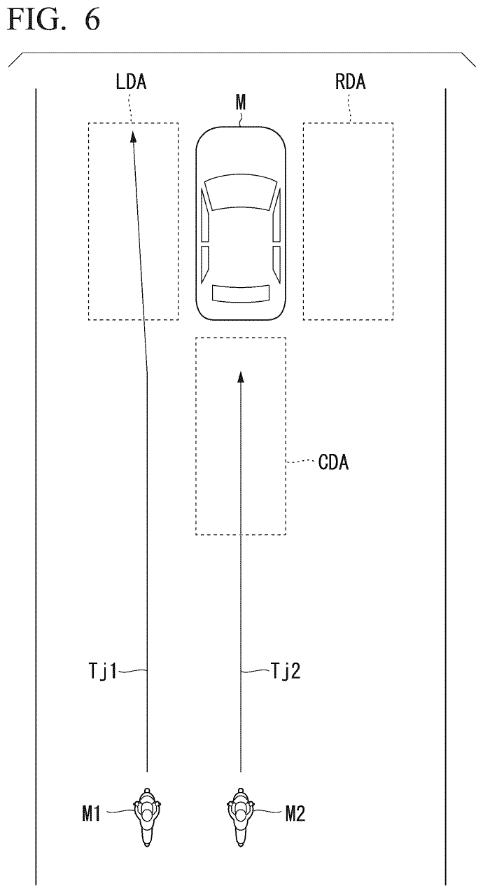

FIG. 6 is a view showing an example of a case where an object is predicted to approach the host vehicle M from behind the host vehicle M and a case where an object is predicted to pass by a side of the host vehicle M. In FIG. 6, Tj1 indicates a future trajectory of a target vehicle M1, and Tj2 indicates a future trajectory of a target vehicle M2. For example, the control unit 160 sets, at the rear toward the center of the host vehicle M, a central determination area CDA for determining the approach of an object and also sets, on the sides of the host vehicle M, a left determination area LDA and a right determination area RDA for determining the passage of an object.

The control unit 160 predicts that an object will approach the host vehicle M in a case where the predicted future trajectory Tj of the object enters the central determination area CDA. On the other hand, the control unit 160 predicts that an object will pass by the side of the host vehicle M in a case where the predicted future trajectory Tj of the object enters the left determination area LDA or the right determination area RDA. In the case of FIG. 6, the future trajectory Tj1 of the target vehicle M1 falls within the left determination area LDA, and the future trajectory Tj2 of the target vehicle M2 falls within the central determination area CDA. Therefore, the control unit 160 predicts that the target host vehicle M1 will pass by the side of the host vehicle M and also predicts that the target host vehicle M2 will approach the host vehicle M. It is noted that in FIG. 6, although the approach prediction and the passage prediction are made based on whether or not the predicted trajectory falls within a determination area that has been set in advance, the present invention is not limited to such a configuration. Therefore, the passage prediction may be made, for example, based on whether or not an extension line of the front end part of the host vehicle M intersects with the future trajectory.

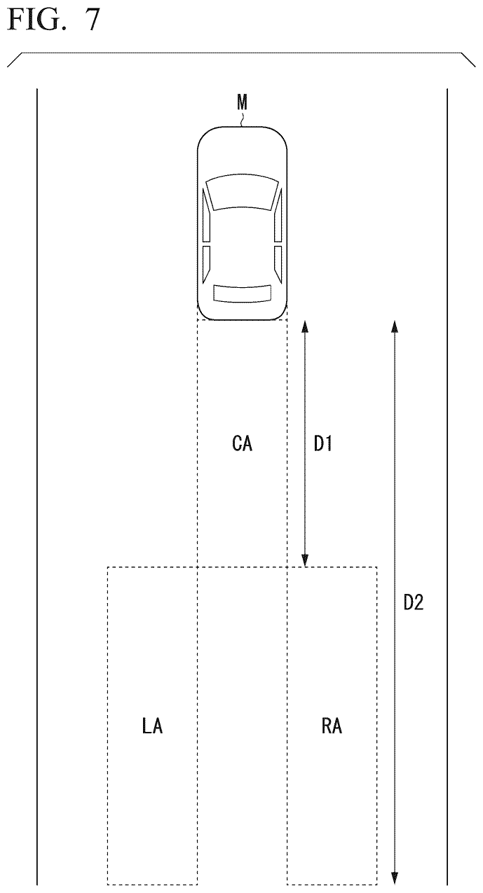

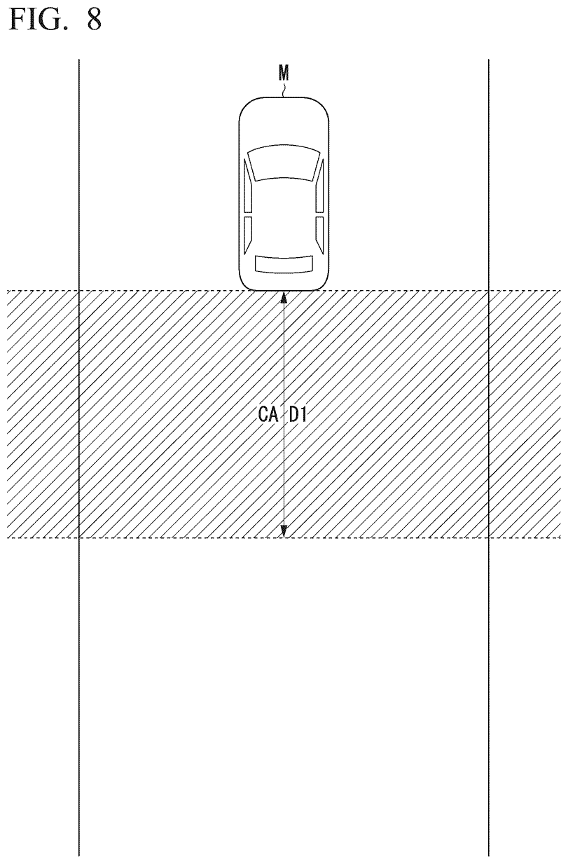

Regarding an object that has been predicted to pass by the side of the host vehicle M and an object that has been predicted to approach the host vehicle M, the control unit 160 determines whether or not the objects have actually entered a predetermined area, and in a case where it has been determined that the object has entered the predetermined area, the control unit 160 causes the notification device to issue a notification. FIG. 7 is a view showing an example of a predetermined area behind the host vehicle M and a predetermined area on the side of the host vehicle M, which are used in order for a control unit 160 to determine whether or not notification is necessary. In FIG. 7, a symbol CA indicates a predetermined area at the rear toward the center of host vehicle M, a symbol LA indicates a predetermined area behind a side (left) of host vehicle M, and a symbol RA indicates a predetermined area behind a side (right) of host vehicle M. The predetermined area behind the host vehicle M is an example of the “first predetermined area,” and the predetermined area on the side of the host vehicle M is an example of the “second predetermined area.”

As shown in FIG. 7, the central area CA is defined, for example, as an area that is allowed to extend from the rear end part of the host vehicle M by a distance D1 in a direction opposite to the direction of progress of the host vehicle M. The left side area LA is defined, for example, as a region in the region to the left of the host vehicle M in a direction opposite to the direction of progress of the host vehicle M, where the region is present away from the rear end part of the host vehicle M by a distance D1 or more and within a distance D2 that is larger than the first distance. The right side area RA is defined, for example, as a region in the region to the right of the host vehicle M in a direction opposite to the direction of progress of the host vehicle M, where the region is present away from the rear end part of the host vehicle M by the distance D1 or more and within the distance D2. In a case where the control unit 160 has carried out such an identification that an object predicted to approach the host vehicle or pass by the side of the host vehicle M has entered any of the central area CA, the left area LA, or the right area RA, the control unit 160 causes the notification device to notify a vehicle occupant in the host vehicle M of the presence of the object in a mode corresponding to the identified area.

It is noted that, in FIG. 7, in the side area LA or RA on the side of the host vehicle M, the distance from the host vehicle M is set to be long as compared with that in the central area CA relating to the central part of the host vehicle M. This is because, in general, a vehicle occupant in the host vehicle M needs to use the side mirrors of the host vehicle M in order to check the side area LA or RA relating to the side of the host vehicle M, and thus it tends to take a long time to carry out checking as compared with the central area CA where the checking can be carried out using the rearview mirror of the host vehicle M. By setting the distance to the side area LA or RA longer, a vehicle occupant in the host vehicle M can check the area on the side of the host vehicle M with a margin.

FIG. 8 is a view showing another example of a predetermined area behind the host vehicle M and a predetermined area on the side of the host vehicle M, which are used in order for a control unit 160 to determine whether or not notification is necessary. In FIG. 8, the predetermined area CA may be defined as an area within the distance D1 in a direction opposite to the direction of progress of the host vehicle M. In other words, the control unit 160 may carry out such an identification that an object predicted to approach the host vehicle M has entered the predetermined area CA in a case where the distance between the host vehicle M and the object is within D1. The same applies to the left side area LA and the right side area RA, and the control unit 160 may carry out such an identification that the object predicted to pass by the side of the host vehicle M has entered the left side area LA or the right side area RA in a case where the distance between the host vehicle M and the object is within D2. More generally, the central area CA, the left area LA, and the right area RA may be defined as a finite region, as in FIG. 7, or may be defined as an infinite region extending infinitely in any direction, as in FIG. 8.

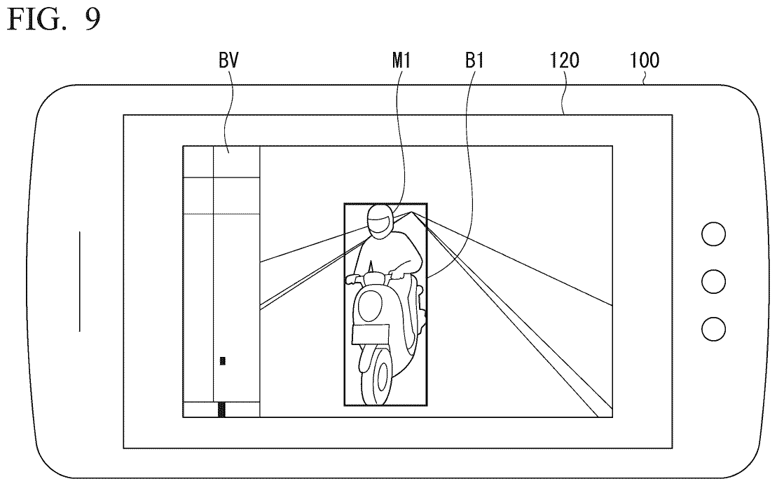

FIG. 9 is a view for an explanatory description of an operation of a notification device in a case where an object has entered the central area CA. FIG. 9 shows a scene in which the two-wheel vehicle M1 has entered the central area CA. In this case, the control unit 160 causes the voice output unit 130 to output a warning sound (for example, “Center!”) that indicates that the two-wheel vehicle M1 has entered the central area CA and is approaching the host vehicle M.

Further, in FIG. 9, a symbol B1 indicates a bounding box that surrounds the two-wheel vehicle M1, and the display unit 120 displays the object recognized by the recognition unit 140 together with a bounding box B1. Further, a symbol BV indicates a bird's eye view showing the surroundings of the host vehicle M, and the display unit 120 displays the position of the object on the virtual plane S, which is derived by the prediction unit 150. The displays of the bounding box and the bird's eye view are merely examples, and other information suitable for driving assistance may be displayed.

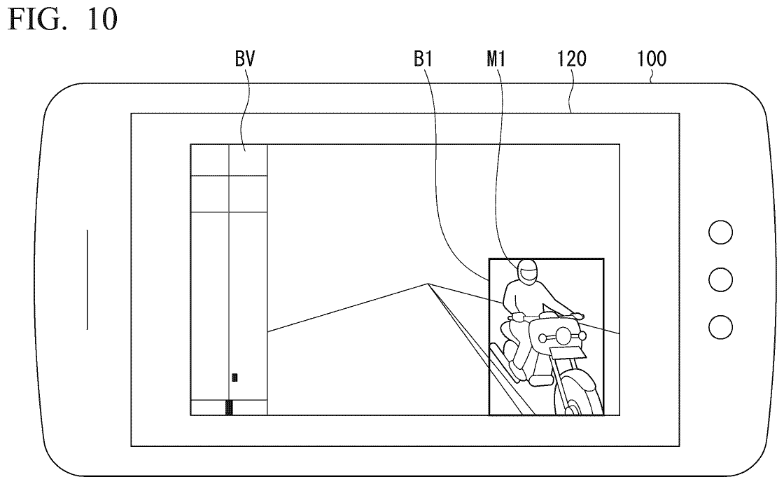

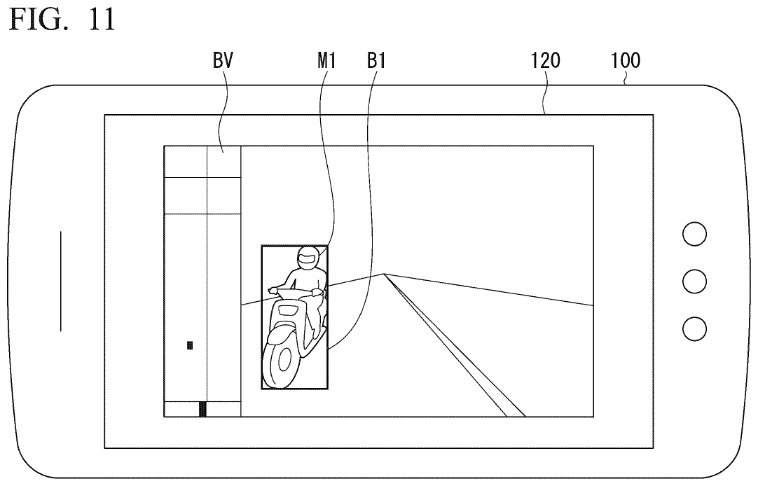

FIG. 10 is a view for an explanatory description of an operation of the notification device in a case where an object has entered a left area LA. FIG. 10 shows a scene in which the two-wheel vehicle M1 has entered the left side area LA. In this case, the control unit 160 causes the voice output unit 130 to output a warning sound (for example, “Left!”) that indicates that the two-wheel vehicle M1 enters the left area LA and passes by the left of the host vehicle M.

FIG. 11 is a view for an explanatory description of an operation of the notification device in a case where an object has entered a right area RA. FIG. 11 shows a scene in which the two-wheel vehicle M1 has entered the right area RA. In this case, the control unit 160 causes the voice output unit 130 to output a warning sound (for example, “Right!”) that indicates that the two-wheel vehicle M1 enters the right area RA and passes by the right of the host vehicle M.

It is noted that in the above description, in the scene of FIG. 11, the control unit 160 causes the voice output unit 130 to output a warning sound (for example, “Center!”) that indicates that the two-wheel vehicle M1 is predicted to enter the central area CA. However, the present invention is not limited to such a configuration, and for example, the control unit 160 may cause the voice output unit 130 to output any electronic sound that does not have a specific meaning. This is because, in a case where a warning sound is meaningful for the side area, a vehicle occupant in the host vehicle M can identify that the warning sound is intended for the central area, hypothetically even in a case where the warning sound is meaningless for the central area.

In this way, by predicting the future trajectory of an object present behind the host vehicle M and changing the mode of notification between a case where the predicted future trajectory is predicted to approach the host vehicle M from behind the host vehicle M and a case where the object is predicted to pass by the host vehicle M, it is possible to notify a vehicle occupant in the mobile body in an optimal manner according to the predicted future trajectory of the surrounding object.

The reception unit 170 receives instruction information that indicates whether the host vehicle M is a four-wheel vehicle or a two-wheel vehicle. The control unit 160 changes, as described below, the mode of notification by the notification device according to the instruction information received by the reception unit 170.

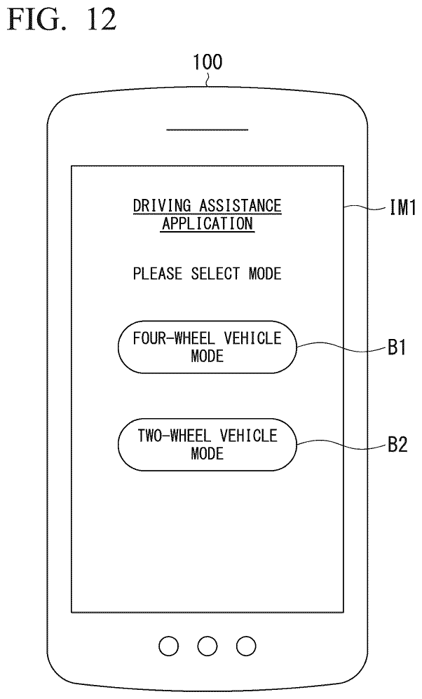

FIG. 12 is a view showing an example of a reception screen IM1 for instruction information that is received by a reception unit 170. The reception screen IM1 is, for example, a screen that is displayed in a case where a user of the terminal device 100 downloads and installs a driving assistance application via a network (not shown in the drawing) and allows the driving assistance application to start up for the first time. In addition, for example, the screen may be displayed in response to a user's selection even after allowing the driving assistance application to start up for the first time.

In FIG. 12, the symbol B1 indicates a button (software switch) with which a user of the terminal device 100 carries out selection in a case where the host vehicle M is a four-wheel vehicle, and the symbol B2 indicates a button with which a user of the terminal device 100 carries out selection in a case where the host vehicle M is a two-wheel vehicle. As will be described below, the reception unit 170 receives the selection of the four-wheel vehicle mode B1 or the two-wheel vehicle mode B2 by a user, and the control unit 160 controls the display by the display unit 120 in response to the received mode.

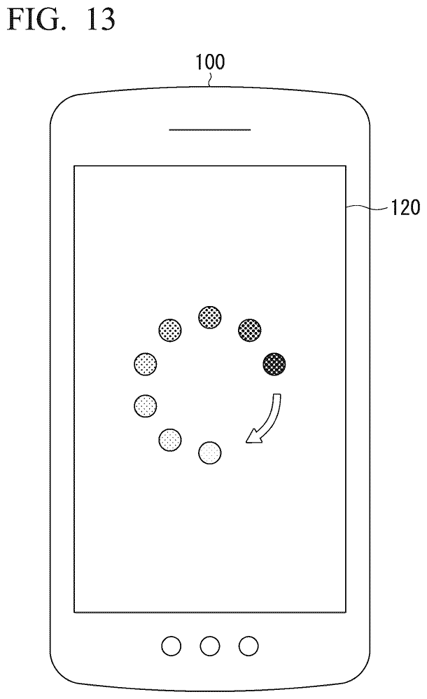

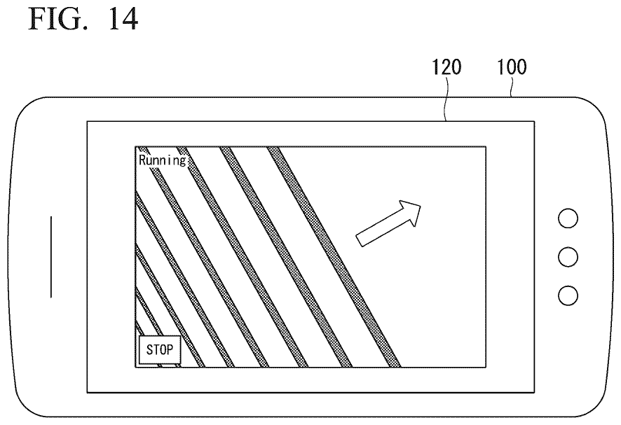

FIG. 13 is a view showing an example of a screen that is displayed by a display unit 120 in a case where the host vehicle M is a two-wheel vehicle. FIG. 13 shows a screen displayed by the display unit 120 which is caused to carry out display by the control unit 160, in a case where an object predicted to approach the host vehicle M from behind the host vehicle M has entered the central area CA. As shown in FIG. 13, in a case where an object predicted to approach the host vehicle M from behind the host vehicle M has entered the central area CA, the control unit 160 causes the display unit 120 to display a predetermined figure in the vicinity of the center of the screen of the terminal device 100. This visually transfers to a vehicle occupant in the host vehicle M the fact that an object is approaching the host vehicle M from behind toward the center of the host vehicle M.

For example, in the case of the screen shown in FIG. 13, the display unit 120 dynamically displays a plurality of dot-shaped objects in the central part of the screen so that a circle is drawn clockwise. On the other hand, in a case where an object predicted to pass by the side of the host vehicle M has entered the side area LA or RA, the control unit 160 causes the display unit 120 not to display a specified figure on the screen of the terminal device 100. This is considered to be because, in a case where the host vehicle M is a two-wheel vehicle, as compared with an object approaching the host vehicle M diagonally from behind the host vehicle M, an object approaching the host vehicle M from behind toward the center of the host vehicle M (that is, an object that poses a risk of rear-end collision) is generally a target to which more attention should be paid by a vehicle occupant in the host vehicle M.

FIG. 14 is a view showing an example of a screen that is displayed by the display unit 120 in a case where the host vehicle M is a four-wheel vehicle. FIG. 14 shows a screen displayed by the display unit 120 which is caused to carry out display by the control unit 160, in a case where an object predicted to pass by the left of the host vehicle M has entered the left area LA. As shown in FIG. 14, in a case where an object predicted to pass by the left of the host vehicle M has entered the left area LA, the control unit 160 causes the display unit 120 to display a predetermined figure diagonally upward from the lower left corner portion of the display unit 120, which corresponds to the left side area LA. Similarly, in a case where an object predicted to pass by the right of the host vehicle M has entered the right area RA, the control unit 160 causes the display unit 120 to display a predetermined figure diagonally upward from the lower right corner portion of the display unit 120, which corresponds to the right side area RA. This visually transfers to a vehicle occupant in the host vehicle M the fact that an object is about to pass by the side of the host vehicle M.

For example, in the case of the screen shown in FIG. 14, the display unit 120 carries out display so that a plurality of linear objects flow diagonally upward from the lower left corner portion of the display unit 120, which corresponds to the left area LA. Similarly, in the present embodiment, in a case where an object predicted to pass by the right of the host vehicle M has entered the right area RA, the display unit 120 carries out display so that a plurality of linear objects flow diagonally upward from the lower right corner portion of the display unit 120, which corresponds to the right area RA. On the other hand, in a case where an object predicted to approach the host vehicle M from behind thereof has entered the central area CA, the control unit 160 causes the display unit 120 not to display a specified figure on the screen of the terminal device 100. This is considered to be because, in a case where the host vehicle M is a four-wheel vehicle, as compared with an object approaching the host vehicle M from behind toward the center of the host vehicle M, an object approaching the host vehicle M diagonally from behind the host vehicle M (that is, an object that poses a risk of being entangled by the host vehicle M) is generally a target to which more attention should be paid by a vehicle occupant in the host vehicle M.

Further, in a case where an object has entered a predetermined area, the control unit 160 may change the mode of display by the display unit 120 in response to the relationship between the object and the host vehicle M. For example, the control unit 160 may calculate an index value (for example, relative speed or time to collision (TTC)) that indicates the degree of approach of an object to the host vehicle M, based on the magnification rate of the object imaged in time series by the on-vehicle camera 10, and then the control unit 160 may increase a speed at which the predetermined figure is dynamically displayed, as the calculated index value is larger. For example, in the case of the screen shown in FIG. 13, the display unit 120 may increase a speed at which a plurality of dot-shaped objects are displayed as a circle drawn clockwise, as the calculated index value indicating the degree of approach is larger. In the case of the screen shown in FIG. 14, the display unit 120 may increase a speed at which a plurality of linear objects flow. In addition, for example, the control unit 160 may calculate the distance between the object and the host vehicle M, and the display unit 120 may display the object thicker (larger) as the calculated distance is smaller so that a vehicle occupant in the host vehicle M is alerted to pay attention.

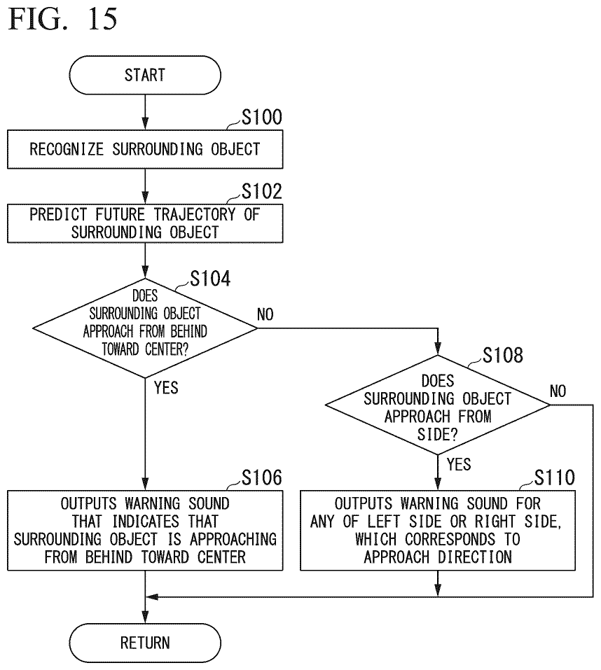

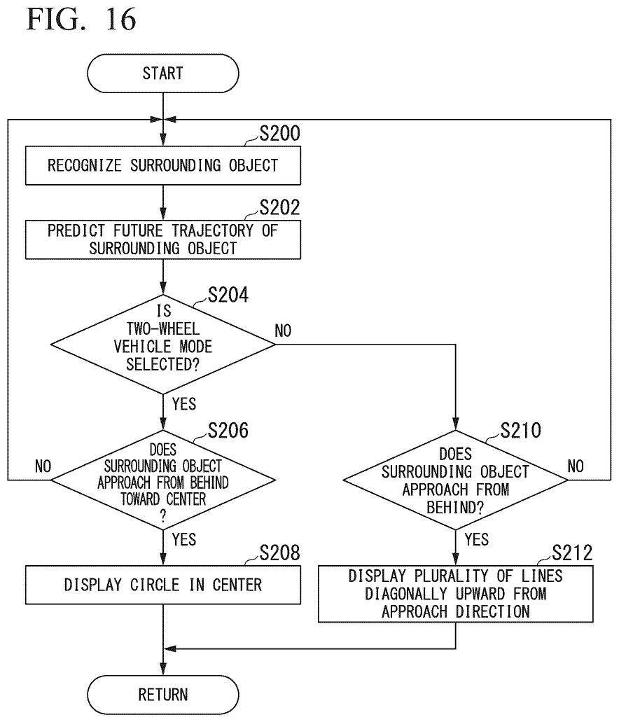

Next, the flow of processing executed by the terminal device 100 will be described with reference to FIG. 15 and FIG. 16. FIG. 15 is a flowchart showing an example of a flow of processing that is executed by a terminal device 100. The processing of the flowchart in FIG. 15 is repeatedly executed according to a predetermined control cycle while the host vehicle M is traveling.

First, the recognition unit 140 recognizes an object in the vicinity of the host vehicle M, which is pictured in the image that has been captured by the on-vehicle camera 10 (step S100). Next, the prediction unit 150 predicts a future trajectory of the surrounding object recognized by the recognition unit 140 (step S102).

Next, the control unit 160 determines whether or not the recognized surrounding object is approaching the host vehicle M from behind the host vehicle M, more specifically, whether or not the future trajectory predicted by the prediction unit 150 has entered the central determination area CDA and the surrounding object has also entered the central area CA (step S104). In a case where it is determined that a surrounding object is approaching the host vehicle M from behind the host vehicle M, the control unit 160 causes the voice output unit 130 to output a warning sound indicating that a surrounding object is approaching the host vehicle M from behind toward the center of the host vehicle M (step S106).

On the other hand, in a case where it is not determined that a surrounding object is approaching the host vehicle M from behind the host vehicle M, the control unit 160 determines whether or not the surrounding object is approaching the host vehicle M from the side of the host vehicle M, more specifically, whether or not the future trajectory predicted by the prediction unit 150 has entered the side determination area (the left side determination area LDA or the right side determination area RDA) and the surrounding object has also entered the side area (the left side area LA or the right side area RA) (step S108). In a case where it is determined that a surrounding object is approaching the host vehicle M from the side of the host vehicle M, the control unit 160 causes the voice output unit 130 to output a warning sound for any of the left side or the right side, which corresponds to the approach direction (step S110). This makes the processing of the present flowchart end.

FIG. 15 is a flowchart showing another example of the flow of processing that is executed by the terminal device 100. The processing of the flowchart in FIG. 15 is executed in a case where the terminal device 100 allows the driving assistance application to start up.

First, the recognition unit 140 recognizes an object in the vicinity of the host vehicle M, which is pictured in the image that has been captured by the on-vehicle camera 10 (step S200). Next, the prediction unit 150 predicts a future trajectory of the surrounding object recognized by the recognition unit 140 (step S202).

Next, the control unit 160 determines whether or not the host vehicle M is a two-wheel vehicle, more specifically, whether or not a mode received by the reception unit 170 is the two-wheel host vehicle mode (step S204). In a case where it is determined that the host vehicle M is a two-wheel vehicle, the control unit 160 determines whether or not the recognized surrounding object is approaching the host vehicle M from behind the host vehicle M, similarly to the step S104 (step S206). In a case where it is determined that the recognized surrounding object is approaching the host vehicle M from behind the host vehicle M, the control unit 160 causes the display unit 120 to display a plurality of dot-shaped objects so that a circle is drawn clockwise (step S208). On the other hand, in a case where it is not determined that the recognized surrounding object is approaching the host vehicle M from behind the host vehicle M, the control unit 160 returns the processing to the step S200.

In a case where it is determined that the host vehicle M is a four-wheel vehicle, the control unit 160 determines whether or not the recognized surrounding object is approaching the host vehicle M from the side of the host vehicle M, similarly to the step S108 (step S210). On the other hand, in a case where it is determined that the predicted surrounding object is not approaching the host vehicle M from the side of the host vehicle M, the control unit 160 returns the processing to the step S200. On the other hand, in a case where it is determined that the predicted surrounding object is approaching the host vehicle M from the side of the host vehicle M, the control unit 160 causes the display unit 120 to display a plurality of linear objects diagonally upward from the corner portion corresponding to the approach direction (step S212). As a result, this makes the processing of the present flowchart end.

It is noted that in the above description, the driving assistance application includes the reception unit 170, and the reception unit 170 changes the mode of notification by the notification device according to whether the host vehicle M is a four-wheel vehicle or a two-wheel vehicle. However, the present invention is not limited to such a configuration, and the driving assistance application may be provided separately as an application dedicated to a four-wheel vehicle, which is installed in a four-wheel vehicle, and an application dedicated to a two-wheel vehicle, which is installed in a two-wheel vehicle. In this case, the application dedicated to a four-wheel vehicle executes the processing shown in the flowchart of FIG. 15 and also causes the display unit 120 to display a plurality of linear objects diagonally upward from the corner portion corresponding to the approach direction in a case where it is predicted that a surrounding object will approach the host vehicle M from the side of the host vehicle M. On the other hand, the application dedicated to a two-wheel vehicle executes the processing shown in the flowchart of FIG. 15 and also causes the display unit 120 to display a plurality of dot-shaped objects so that a circle is drawn clockwise, in a case where it is predicted that a surrounding object will approach the host vehicle M from behind the host vehicle M.

According to the present embodiment described as above, the future trajectory of the surrounding object recognized by the recognition unit is predicted, and the mode of notification by the notification device is changed according to the predetermined area which the predicted future trajectory will enter. Further, the mode of notification by the notification device is changed according to whether the host vehicle M is a two-wheel vehicle or a four-wheel vehicle. This makes it possible to make a notification to an occupant of a mobile body in an optimal manner according to the predicted future trajectory of a surrounding vehicle.

The above-described embodiment can be expressed as follows.

An information processing device including a storage medium that stores computer-readable instructions; and
a processor connected to the storage medium,
where the processor executes the computer-readable instructions to: recognize an object included in image data obtained by capturing an image of a vicinity of a mobile body,
predict a future trajectory of the object,
cause a notification device to notify an occupant of the mobile body of the presence of the object based on the future trajectory of the object, and
change a mode of notification by the notification device between a case where the object is predicted to approach from behind the mobile body and a case where the object is predicted to pass by a side of the mobile body.

Hereinabove, the form for carrying out the present invention was described using the embodiments. However, the present invention is not limited at all to such embodiments, and various modifications and substitutions can be made within the scope that does not deviate from the gist of the present invention.

### REFERENCE SIGNS LIST

10 On-vehicle camera
100 Terminal device
110 Communication unit
120 Display unit
130 Voice output unit
140 Recognition unit
150 Prediction unit
160 Control unit
170 Reception unit

What is claim is:

1. An information processing device comprising:
a recognition unit that recognizes an object included in image data obtained by capturing an image of a vicinity of a mobile body;
a prediction unit that predicts a future trajectory of the object; and
a notification control unit that causes a notification device to notify a vehicle occupant in the mobile body of the presence of the object based on the future trajectory of the object,
wherein the notification control unit changes a mode of notification by the notification device between a case where the object is predicted to approach the mobile body from behind the mobile body and a case where the object is predicted to pass by a side of the mobile body.

2. The information processing device according to claim 1,
wherein the notification device is a voice output device, and
the notification control unit causes the voice output device to output a warning sound in a case where the object is predicted to approach the mobile body from behind the mobile body and the object has entered a first predetermined area.

3. The information processing device according to claim 1,
wherein the notification device is a voice output device, and
the notification control unit outputs a warning sound indicating whether the side is left or right in a case where the object is predicted to pass by the side of the mobile body and the object has entered a second predetermined area.

4. The information processing device according to claim 2,
wherein the notification control unit outputs a warning sound indicating whether the side is left or right in a case where the object is predicted to pass by the side of the mobile body and the object has entered a second predetermined area,
the first predetermined area is an area that is present within a first distance from the mobile body, and
the second predetermined area is an area that is present away from the mobile body by the first distance or more and within a second distance that is larger than the first distance.

5. The information processing device according to claim 1,
wherein the notification device is a display device,
the information processing device further includes a reception unit that receives instruction information indicating whether the mobile body is a four-wheel vehicle or a two-wheel vehicle, and
in a case where the reception unit receives instruction information indicating that the mobile body is a two-wheel vehicle, the notification control unit causes the display device to display a predetermined figure in a central part of the display device in a case where the object is predicted to approach the mobile body from behind the mobile body and the object has entered a first predetermined area.

6. The information processing device according to claim 1, wherein the notification device is a display device,
the information processing device further includes a reception unit that receives instruction information indicating whether the mobile body is a four-wheel vehicle or a two-wheel vehicle, and
in a case where the reception unit receives instruction information indicating that the mobile body is a four-wheel vehicle, the notification control unit causes the display device to dynamically display a predetermined figure diagonally upward from a lower left corner portion or a lower right corner portion of the display device, which corresponds to a direction in which the object has entered, in a case where the object is predicted to pass by the side of the mobile body and the object has entered a second predetermined area.

7. The information processing device according to claim 6, wherein the notification control unit increases a speed at which the predetermined figure is dynamically displayed as a relative speed of the object with respect to a speed of the mobile body increases.

8. The information processing device according to claim 6, wherein the notification control unit increases a size of the predetermined figure as the object approaches the mobile body.

9. An information processing method, wherein a computer recognizes an object included in image data obtained by capturing an image of a vicinity of a mobile body,
predicts a future trajectory of the object,
causes a notification device to notify a vehicle occupant in the mobile body of the presence of the object based on the future trajectory of the object, and
changes a mode of notification by the notification device between a case where the object is predicted to approach the mobile body from behind the mobile body and a case where the object is predicted to pass by a side of the mobile body.

10. A non-transitory computer-readable storage having stored thereon a program for causing a computer to execute:
causing a computer to recognize an object included in image data obtained by capturing an image of a vicinity of a mobile body such that a future trajectory of the object is predicted, and;
causing a notification device to notify a vehicle occupant in the mobile body of the presence of the object based on the future trajectory of the object such that a mode of notification by the notification device is changed between a case where the object is predicted to approach the mobile body from behind the mobile body and a case where the object is predicted to pass by a side of the mobile body.

11. A non-transitory computer-readable storage having stored thereon a program for causing a computer to execute:
causing a computer to recognize an object included in image data obtained by capturing an image of a vicinity of a two-wheel vehicle such that a future trajectory of the object is predicted;
causing a notification device to notify a vehicle occupant in the two-wheel vehicle of the presence of the object based on the future trajectory of the object;
causing the computer to change a mode of notification by the notification device between a case where the object is predicted to approach the two-wheel vehicle from behind the two-wheel vehicle and a case where the object is predicted to pass by a side of the two-wheel vehicle, and;
causing the notification device to display a predetermined figure in a central part of the notification device in a case where the object is predicted to approach the two-wheel vehicle from behind the two-wheel vehicle and the object has entered a first predetermined area.

12. A non-transitory computer-readable storage having stored thereon a program for causing a computer to execute:
causing a computer to recognize an object included in image data obtained by capturing an image of a vicinity of a four-wheel vehicle such that a future trajectory of the object is predicted;
causing a notification device to notify a vehicle occupant in the four-wheel vehicle of the presence of the object based on the future trajectory of the object;
causing the computer to change a mode of notification by the notification device between a case where the object is predicted to approach the four-wheel vehicle from behind the four-wheel vehicle and a case where the object is predicted to pass by a side of the four-wheel vehicle, and;
causing the notification device to dynamically display a predetermined figure diagonally upward from a lower left corner portion or a lower right corner portion of the notification device, which corresponds to a direction in which the object has entered, in a case where the object is predicted to pass by the side of the four-wheel vehicle and the object has entered a second predetermined area.
